(19) United States
(12) Patent Application Publication
(10) Pub. No.: US 2026/0178394 A1
(43) Pub. Date: Jun. 25, 2026

(54) HETEROGENEOUS SERVER SYSTEM AND METHOD OF USING THE SAME

(71) Applicant: CLOUD INTELLIGENCE ASSETS HOLDING (SINGAPORE) PRIVATE LIMITED, Singapore (SG)

(72) Inventor: Zhibing LI, Chengdu, Sichuan (CN)

(21) Appl. No.: 19/124,742

(22) PCT Filed: Oct. 24, 2023
(86) PCT No.: PCT/CN2023/126246

§ 371 Date: Apr. 25, 2025

(30) Foreign Application Priority Data
Oct. 25, 2022 (CN) 202211311808.2

(51) Int. Cl. G06F 9/50; G06F 9/455; G06F 13/42

(52) U.S. Cl. CPC G06F 9/5027; G06F 9/455; G06F 13/4221

(57) ABSTRACT

The present disclosure relates to a heterogeneous server system and a method of using the same. The heterogeneous server system includes: a first computing node, configured to provide a first service; a second computing node, configured to provide a second service; and a computing resource node, including a switch and a computing processing unit connected to the switch. The computing processing unit is configured to execute at least a part of a computing task of the first service or the second service. The switch is connected to the first computing node and the second computing node, and is switchable between a first state and a second state. In the first state, the switch connects the computing processing unit to the first computing node, and in the second state, the switch connects the computing processing unit to the second computing node.

### CROSS-REFERENCE TO RELATED APPLICATIONS

The present application is a National Stage of International Application No. PCT/CN2023/126246, filed on Oct. 24, 2023, which claims priority to Chinese Patent Application No. 202211311808.2, entitled “HETEROGENEOUS SERVER SYSTEM AND METHOD OF USING THE SAME” and filed with the China National Intellectual Property Administration on Oct. 25, 2022. Both of the above applications are incorporated herein by reference in their entireties.

### TECHNICAL FIELD

The present disclosure relates to hardware computing devices for artificial intelligence and, in particular, to a heterogeneous server system that provides composite artificial intelligence services.

### BACKGROUND

Training services and inference services of artificial intelligence models usually require different computing capabilities, so different heterogeneous (e.g., central processing unit (CPU)+graphics processing unit (GPU)) servers are usually designed to meet different service requirements. For example, mainstream training services usually use GPU training servers or OAM (open application model)-based UBB (Universal Baseboard) to provide computing power for them, while inference services usually use servers of single-card GPU type.

Currently, heterogeneous server hardware (e.g., the ratio between CPU, GPU, and memory) designed for training services does not match the inference service requirements. If a training server is used for inference services, CPU and GPU computing power cannot be fully utilized, which causes a waste of computing power. Moreover, the current training servers and inference servers cannot be flexibly switched to achieve flexible switching of training and inference services, so that they cannot follow the peaks and troughs of training and inference requirements, and fail to fully schedule GPU computing power to match service requirements. Therefore, in order to meet the training and inference service requirements at the same time, users usually have to purchase both training servers and inference servers at the same time. However, this is likely to cause a waste of computing power of the two servers during the trough period of their respective service requirements.

Therefore, a new type of heterogeneous server system is needed, which fully utilizes GPU computing power to simultaneously meet the needs of at least two major types of artificial intelligence services (such as training and inference).

### SUMMARY

A technical problem to be solved by the present disclosure is to provide a heterogeneous server system that can provide at least two types of artificial intelligence services in a highly efficient manner.

According to a first aspect of the present disclosure, a heterogeneous server system is provided, including: a first computing node configured to provide a first service; a second computing node configured to provide a second service; and a computing resource node, including a switch and a computing processing unit connected to the switch, where the computing processing unit is configured to perform at least a part of a computing task of the first service or the second service, where the switch is connected to the first computing node and the second computing node, and is switchable between a first state and a second state, where in the first state, the switch connects the computing processing unit to the first computing node, and in the second state, the switch connects the computing processing unit to the second computing node.

In an embodiment, the switch is a PCIe (peripheral component interconnect express) switch; the computing processing unit is connected to a downstream port of the switch via a PCIe cable; the first computing node and the second computing node are connected to a first port and a second port of the switch via a PCIe cable, respectively, and in the first state, the first port is set as an upstream port of the switch and the second port is closed, and in the second state, the second port is set as the upstream port of the switch and the first port is closed.

In an embodiment, the computing resource node further includes a baseboard management controller, and switching of the switch between the first state and the second state is implemented by the baseboard management controller changing a firmware of the switch.

In an embodiment, the computing resource node further includes a baseboard management controller, and the switch further includes an internal processor. Switching of the switch between the first state and the second state is implemented as follows: the switch is configured to enable the baseboard management controller to communicate with the internal processor; the internal processor obtains and saves a PCIe topology of the downstream port; in the first state, the baseboard management controller configures the first port as the upstream port of the switch and closes the second port, and the switch provides the PCIe topology to the first computing node; and in the second state, the baseboard management controller configures the second port as the upstream port of the switch and closes the first port, and the switch provides the PCIe topology to the second computing node.

In an embodiment, the heterogeneous server system includes a plurality of second computing nodes, and the computing resource node includes a plurality of switches and a plurality of computing processing units, where the plurality of computing processing units are divided into a plurality of groups, and each group is connected to one of the plurality of switches, where the first computing node is connected to at least two of the plurality of switches, where each of the plurality of second computing nodes is connected to at least one of the plurality of switches, and a quantity of switches connected with the second computing node is calculated based on a quantity of computing processing units required for the second service and a connection architecture between the computing processing units and the switches, and where a quantity of switches connected with the first computing node is greater than the quantity of switches connected with the second computing node.

In an embodiment, the computing processing unit is a GPU; and/or each of the first computing node and the second computing node includes a CPU and a memory; and/or the first service is an artificial intelligence training service; and/or the second service is an artificial intelligence inference service.

In an embodiment, the computing resource node further includes: a first interface for connecting the first computing node to the first port of the switch; and/or, a second interface for connecting the second computing node to the second port of the switch; and/or, a memory interface for connecting the memory to a third port of the switch.

According to a second aspect of the present disclosure, a method of using the heterogeneous server system according to the first aspect of the present disclosure to perform a computing task is provided, including: determining whether the computing processing unit connected with the switch is used for the first service or the second service; configuring the switch to the first state in a case where the computing processing unit connected with the switch is used for the first service; and configuring the switch to the second state in a case where the computing processing unit connected with the switch is used for the second service.

In an embodiment, the switch is a PCIe switch, and the computing processing unit is connected to a downstream port of the switch via a PCIe cable; the first computing node and the second computing node are connected to a first port and a second port of the switch via a PCIe cable, respectively; and the computing resource node further includes a baseboard management controller. The step of configuring the switch to the first state includes: setting, by the baseboard management controller, a firmware of the switch to a first firmware; setting, by the first firmware, the first port as an upstream port of the switch so as to connect to the downstream port, and closing the second port; and/or, the step of configuring the switch to the second state includes:

setting, by the baseboard management controller, the firmware of the switch to a second firmware; setting, by the second firmware, the second port as the upstream port of the switch so as to connect to the downstream port, and closing the first port.

In an embodiment, the switch is a PCIe switch, and the computing processing unit is connected to a downstream port of the switch via a PCIe cable; the first computing node and the second computing node are connected to a first port and a second port of the switch via a PCIe cable, respectively; the computing resource node further includes a baseboard management controller, and the switch further includes an internal processor. The step of configuring the switch to the first state includes: configuring the switch so that the baseboard management controller communicates with the internal processor; obtaining and saving, by the internal processor, a PCIe topology of the downstream port; and configuring, by the baseboard management controller, the first port as an upstream port of the switch and closing the second port, and providing, by the switch, the PCIe topology to the first computing node; and/or, the step of configuring the switch to the second state includes: configuring the switch so that the baseboard management controller communicates with the internal processor; obtaining and saving, by the internal processor, the PCIe topology of the downstream port; and configuring, by the baseboard management controller, the second port as the upstream port of the switch and closing the first port, and providing, by the switch, the PCIe topology to the second computing node.

In an embodiment, the heterogeneous server system includes a plurality of second computing nodes; the computing resource node includes a plurality of switches and a plurality of computing processing units; the plurality of computing processing units are divided into a plurality of groups, and each group is connected to one of the plurality of switches; the first computing node is connected to at least two of the plurality of switches; each of the plurality of second computing nodes is connected to at least one of the plurality of switches, and a quantity of switches connected with the second computing node is calculated based on a quantity of computing processing units required for the second service and a connection architecture between the computing processing units and the switches; a quantity of switches connected with the first computing node is greater than the quantity of switches connected with the second computing node. The step of determining whether the computing processing unit connected with the switch is used for the first service or the second service includes: determining quantities of computing processing units used for the first service and the second service, respectively, among the plurality of computing processing units according to quantities of the first service and the second service to be provided by the heterogeneous server system; and allocating the plurality of computing processing units to the first service and the second service respectively according to the connection architecture between the computing processing units and the switches, a connection architecture between the first computing node, the second computing nodes and the switches, and the quantity of computing processing units required for each service.

According to a third aspect of the present disclosure, a computing device is provided, including: a processor; and a memory, on which executable codes are stored, and when the executable codes are executed by the processor, the processor is caused to execute the method according to the second aspect.

According to a fourth aspect of the present disclosure, a computer program product is provided, including executable codes, and when the executable codes are executed by a processor of an electronic device, the processor is caused to execute the method according to the second aspect.

According to a fifth aspect of the present disclosure, a non-transitory machine-readable storage medium is provided, on which executable codes are stored, and when the executable codes are executed by a processor of an electronic device, the processor is caused to execute the method according to the second aspect.

Thus in the present disclosure, at least two types of services can be provided by hybrid networking of at least two types of service nodes and computing resource nodes to merge into an integrated physical machine of a composite type. Moreover, the utilization rate of the computing power of the computing resource node can be improved using the flexible switching scheme of the switch, which effectively improves the total cost of ownership (TCO) benefit.

### BRIEF DESCRIPTION OF DRAWINGS

The above and other purposes, features and advantages of the present disclosure will become more apparent by describing the exemplary embodiments of the present disclosure in more detail in conjunction with the accompanying drawings, where the same reference numerals generally represent the same components in the exemplary embodiments of the present disclosure.

FIG. 1 illustrates a schematic block diagram of a heterogeneous server system according to an embodiment of the present disclosure.

FIG. 2 illustrates a schematic flow chart of a method of using a heterogeneous server system according to an embodiment of the present disclosure.

FIG. 3 illustrates a schematic block diagram of a specific example of a heterogeneous server system according to an embodiment of the present disclosure.

FIG. 4 illustrates a schematic structural diagram of a computing device according to an embodiment of the present disclosure.

### DESCRIPTION OF EMBODIMENTS

The embodiments of the present disclosure will be described in more detail below with reference to the accompanying drawings. Although the embodiments of the present disclosure are shown in the accompanying drawings, it should be understood that the present disclosure can be implemented in various forms and should not be limited by the embodiments described herein. On the contrary, these embodiments are provided to make the present disclosure more thorough and complete, and to fully convey the scope of the present disclosure to those skilled in the art.

In order to solve the aforementioned technical problem, in the present disclosure, a flexible allocation of the computing power of a computing processing unit is achieved by connecting at least two computing nodes providing different services to the computing processing unit via a switch, so as to efficiently utilize computing resources (i.e., computing processing units) to provide at least two different services.

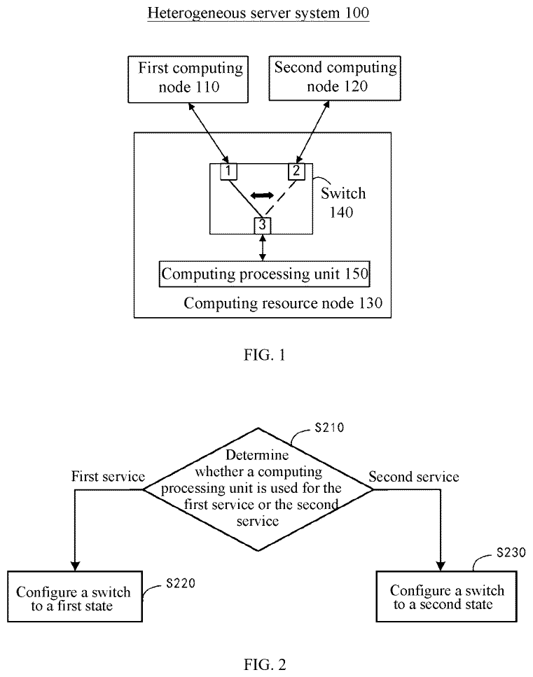

The basic concept of the present invention is described below in conjunction with FIG. 1 and FIG. 2.

FIG. 1 illustrates a schematic block diagram of a basic architecture of a heterogeneous server system according to an embodiment of the present disclosure.

As shown in FIG. 1, a heterogeneous server system 100 includes a first computing node 110, a second computing node 120, and a computing resource node 130. The computing resource node 130 includes a switch 140 and a computing processing unit 150. The first computing node 110, the second computing node 120, and the computing processing unit 150 are connected to three ports 1-3 of the switch 140, respectively.

A solid line connecting ports 1 and 3 of the switch 140 shown in FIG. 1 schematically represents a first state of the switch 140, in which the computing processing unit 150 is connected to the first computing node 110, while a dashed line connecting ports 2 and 3 shown in FIG. 1 schematically represent a second state of the switch 140, in which the computing processing unit 150 is connected to the second computing node 120. As shown by the thicker arrow in FIG. 1, the switch 140 can switch between the first state and the second state, thereby selecting whether to connect the computing processing unit 150 to the first computing node 110 or the second computing node 120.

Those skilled in the art should understand that the structure of the switch 140 shown in the figure is only a simple schematic diagram for its function, and does not represent the physical structure of the switch disclosed in the present invention; the connections represented by all the lines in the figure are not limited to direct physical connections, but may also include indirect connections via intermediate interfaces, or wireless connections, etc.

The first computing node 110 and the second computing node 120 are configured to provide a first service and a second service, respectively, such as an artificial intelligence training service and an artificial intelligence inference service. In some embodiments of the present disclosure, the first computing node 110 and the second computing node 120 may be general-purpose computers or servers, each of which may include a CPU and a memory to perform operations of the first/second service. Since artificial intelligence services usually require higher computing power, these general-purpose computers or servers need additional computing resources to meet the computing power required for their services, that is, to connect to the computing resource node 130 to utilize the computing processing unit 150 therein to perform at least a part of the computing tasks of the first or second service. In some other embodiments, the first computing node 110 and the second computing node 120 may also be specially designed hardware architectures to utilize the computing power of the computing resource node 130 to perform at least a part of the computing tasks of the first/second service.

The computing processing unit 150 may be a GPU, but the present disclosure is not limited thereto, and the computing processing unit 150 may include various computing processing hardware that can provide the required computing power for various artificial intelligence services, such as ASIC or FPGA.

In some embodiments of the present disclosure, the switch 140 may be a PCIe switch, and the first computing node 110, the second computing node 120 and the computing processing unit 150 are connected to ports 1-3 of the switch 140 via PCIe cables. By setting the switch 140, port 3 may be set as a downstream port, and one of ports 1 and 2 may be set as an upstream port and the other may be closed as needed, thereby achieving flexible switching of the switch between the two states. Of course, the present invention is not limited to this, but the network connection between each computing node and the computing processing unit may also be achieved through, for example, a network interface controller (NIC). For example, through the remote direct memory access (RDMA) technology between the NIC and the GPU, the GPU computing power may be flexibly provided for the first or second computing node. Compared with the RDMA technology using the NIC, the solution using the PCIe switch for interconnection has lower system latency and lower software complexity.

Those skilled in the art should understand that although only two computing nodes, a switch and a computing processing unit are shown in FIG. 1, the present invention is not limited to this. As required, the system 100 may also include another computing node to provide another service, and/or multiple first/second computing nodes, and/or multiple switches and computing processing units. A computing node may be connected to two or more switches, a switch may be connected to two or more computing processing units, and a switch may also be connected to two or more computing nodes. In practical applications, the quantity of components and the connection architecture included in the system may be designed according to conditions such as the types of services that the system needs to provide, the quantity of each service required, and the computing power requirements of each service for computing resources. In some cases, the computing power required for the first service is more than that for the second service, so the first computing node may be connected to more switches, or the first computing node may be connected to each switch so that the computing task of the first service can be performed using all the computing power.

A method for implementing the basic concept of the present invention using the heterogeneous server system 100 of FIG. 1 is described below in conjunction with FIG. 2.

FIG. 2 illustrates a schematic flow chart of a method of using a heterogeneous server system to perform computing tasks according to an embodiment of the present disclosure.

Please refer to FIG. 2. In step S210, it is determined whether the computing processing unit 150 is used for a first service or a second service. If it is determined to be used for the first service, step S220 is performed to configure the switch 140 to the first state, that is, with the connection relationship shown by the solid line in FIG. 1. If it is determined to be used for the second service, step S230 is performed to configure the switch 140 to the second state, that is, with the connection relationship shown by the dashed line in FIG. 1. Through this method, the computing processing unit 150 can be flexibly scheduled to perform the computing task of a specific service as needed.

The method can be implemented by the heterogeneous server system itself (for example, a CPU of the computing nodes and computing resource node in the system, or other controllers independent of these nodes in the system), or by a control apparatus outside the heterogeneous server system.

In summary, in the present invention, the respective computing nodes that provide different services are connected to the required computing resources via a switch, and computing resources are flexibly provided for the respective computing nodes as needed, so that multiple service requirements can be met by a unified composite physical machine and the utilization of computing resources can be improved.

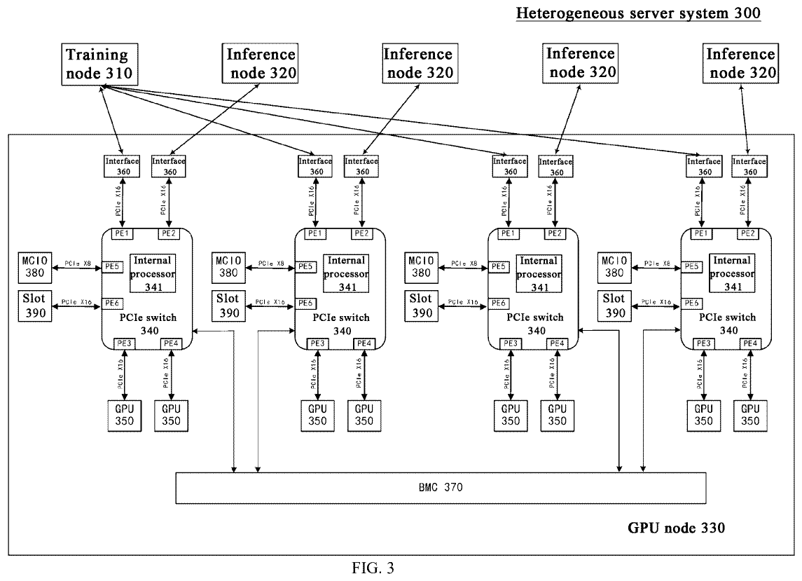

Below, in order to more fully understand the present invention, a specific example of the present disclosure and its operation will be described in conjunction with FIG. 3.

FIG. 3 illustrates a schematic block diagram of a specific example of a heterogeneous server system according to an embodiment of the present disclosure. In this example, the aforementioned first computing node is a training node that provides a model training service, the second computing node is an inference node that provides an inference service, the switch is a PCIe switch, the computing resource node is a GPU node, and the computing processing unit is a GPU.

As shown in FIG. 3, a heterogeneous server system 300 includes one training node 310, 4 inference nodes 320, 4 PCIe switches 340, and 8 GPUs 350. The training node 310 is connected to 4 PCIe switches 340, each inference node 320 is connected to a PCIe switch 340, and each PCIe switch 340 is connected to 2 GPUs 350.

Those skilled in the art should understand that the present invention is not limited to the hardware quantity and architecture shown in FIG. 3, but a composite system can be configured with a reasonable ratio between CPU and GPU according to the hardware requirements of the training and inference service scenarios. The heterogeneous server system disclosed in the present disclosure may also be referred to as a “heterogeneous server composite system”. In the composite system, the training node is connected with the required quantity of GPUs in the GPU nodes via switches to form a network, turning the system into a composite physical machine suitable for a training service, while the inference node is connected with the required quantity of GPUs via switches to form a network, turning the system into a composite physical machine suitable for an inference service, thereby achieving the technical effect of combining the inference nodes, the training node and the GPU nodes into a composite physical machine to meet the inference and training needs.

The training node 310 and inference nodes 320 can each include the same quantity or different quantities of CPUs. In this example, the training node 310 and each inference node 320 can be set to each include 1 CPU, the computing power ratio of CPU to GPU required for the training service is 1:8, and the computing power ratio of CPU to GPU required for the inference service is 1:2, so 8 GPUs are provided at the GPU node 330, and are divided into 4 groups which are connected to 4 PCIe switches respectively, so that a group of GPUs connected to each PCIe switch can be allocated to one inference node for use, and all GPUs connected to all PCIe switches can be allocated to the training node for use at the same time.

According to the quantity of training services and inference services to be provided by the current system, these 8 GPUs can be flexibly allocated to the training node or the inference node.

For example, in some embodiments, when there is only training service but no inference service, all GPUs (i.e., all computing power) can be allocated to the training node, and when an inference service request with a higher priority comes during the training, one of the switches can be switched to the inference node to meet the inference computing task requirements without a need for suspending the current training service, so that the system can run the training service and the inference service at the same time. In other embodiments, the training and inference services can be managed according to priority or in other manners, and all GPUs can be allocated to the training and inference services with maximum utilization efficiency. For example, the GPU computing power can be fully scheduled to match the service requirements according to the peak and trough periods of the training and inference service requirements.

After the allocation scheme of the GPUs to the training node and/or the inference node is confirmed, the driving of each PCIe switch is configured according to the scheme, so that the upstream port of the corresponding PCIe switch is configured to connect to one of the training node and the inference node, and the PCIe channel with the other node is closed, so as to achieve the combination of the GPU computing power and the respective computing nodes to meet the requirements of the corresponding services.

The configuration operation of the PCIe switch 340 is described in detail below in conjunction with FIG. 3.

As shown in FIG. 3, each PCIe switch 340 has 6 PCIe ports PE1-PE6, which are connected to the respective PCIe devices, including GPUs 350, interfaces 360, MCIOs 380, and slots 390, through PCIe cables (the “PCIe X16/X8” shown in the figure indicates 16-bit/8-bit PCIe cables). Of course, the PCIe switch of the present invention is not limited to this. Instead, PCIe ports can be increased or decreased as needed, and the connected PCIe devices can be increased or decreased as needed.

In this example, the training node 310 and the inference nodes 320 cannot be directly connected to the PCIe switches, but are connected via the interfaces 360, that is, they are physically connected to the interfaces 360 through cables and then connected to the PCIe switches 340 via the interfaces 360. In FIG. 3, the interfaces 360 are located in the GPU node 330, but the present invention does not limit the location of the interfaces, that is, the interfaces may also be independent of each node or installed in each computing node.

MCIO (Mini Cool edge I/O, mini cool edge input/output interface) 380 may be used as a PCIe-supported memory interface for connecting a memory (such as an SSD or a hard disk, etc.) to a PCIe switch. Of course, the present invention is not limited to such a memory interface, and the memory required for the service may also be provided in other ways, not limited to being connected to the switch as shown in the figure.

Slot 390 can connect other required PCIe devices, or leave room for PCIe devices that need to be connected in the future.

In addition, FIG. 3 illustrates that the GPU node 330 further includes a baseboard management controller (BMC) 370, which is connected to each PCIe switch 340.

As known to those skilled in the art, a tree-like connection structure is adopted for the PCIe switch, in which there is only one upstream port which is connected to one or more downstream ports. Therefore, according to the present invention, the port connecting the GPU 350 is set as a downstream port, and the flexible switching of the GPU computing power between the training node and the inference node is achieved by flexibly switching the upstream port between PE1 and PE2.

In some embodiments, the switching of the upstream port of the PCIe switch 340 is achieved by the BMC 370 changing the firmware of the PCIe switch 340. The BMC 370 directly refreshes the firmware of the switch, and the firmware sets each port as needed to achieve the required connection.

For example, the system 300 outputs, to the BMC 370, a first firmware for connecting the training node to the respective GPUs and a second firmware for connecting the inference node to the respective GPUs. Then, the BMC 370 selects to load the first firmware or the second firmware to each PCIe switch 340 according to the GPU scheduling scheme generated based on the service requirements. The first and second firmwares can both set ports PE3-PE6 as downstream ports of the switch. The difference between the first and second firmwares is that the first firmware sets port PE1 as the upstream port of the switch and closes port PE2, while the second firmware sets port PE2 as the upstream port of the switch and closes port PE1.

In some other embodiments, the switching of the upstream port of the PCIe switch 340 is achieved by using an internal processor 341 of the switch.

For example, a mode of the PCIe switch 340 is configured to an ssw mode (synthetic switch mode), and a secrouting library is enabled. Here, the secrouting library is a library of enhanced features of the switch, which supports the debugging library of the advanced mode of the switch.

Then, through the secrouting library interface, the BMC 370 can communicate with the internal processor 341 for related configuration and modification.

Then, the internal processor 341 obtains the PCIe topology of the lower layer (i.e., each downstream port) of the PCIe switch and saves it in the cache of the internal processor.

Then, the BMC 370 configures ports PE1 and PE2 through an IIC (inter-integrated circuit bus) out-of-band channel, so as to set one of the ports PE1 and PE2 as an upstream port and close the other as needed.

Then, the PCIe switch 340 synchronizes resources such as a virtual PCIe tree to the training node or the inference node connected to the upstream port, and completes the system PCIe driver resource configuration. The PCIe tree describes the tree connection structure of the switch, which includes the PCIe topology of the downstream ports.

As described above, the training node, the inference nodes and the GPU node are physically networked through PCIe cables according to service requirements, and the GPU computing power is flexibly switched between the training node and the inference node through the configuration of the PCIe switch, thereby achieving the on-demand scheduling and switching of the GPU computing power to integrate the training and inference services, and improving the utilization rate of the GPU computing power.

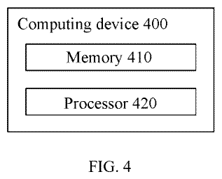

FIG. 4 illustrates a schematic structural diagram of a computing device that may be used to implement the above-mentioned method of using the heterogeneous server system according to an embodiment of the present disclosure. As described above, the computing device that implements the method of the present disclosure can be concurrently served by the computing nodes and computing resource node in the heterogeneous server system, or other computing devices in the system that are independent of these nodes, or a computing device outside the system.

Please refer to FIG. 4. A computing device 400 includes a memory 410 and a processor 420.

The processor 420 may be a multi-core processor, or may include multiple processors. In some embodiments, the processor 420 may include a general main processor and one or more special co-processors, such as a graphics processing unit (GPU), a digital signal processor (DSP), and the like. In some embodiments, the processor 420 may be implemented using a customized circuit, such as an application-specific integrated circuit (ASIC) or a field programmable gate array (FPGA).

The memory 410 may include various types of storage units, such as a system memory, a read-only memory (ROM), and a permanent storage apparatus. Among them, the ROM may store static data or instructions required by the processor 420 or other modules of a computer. The permanent storage apparatus may be a readable and writable storage apparatus. The permanent storage apparatus may be a non-volatile storage device that does not lose the stored instructions and data even after the computer is powered off. In some embodiments, for the permanent storage apparatus, a large-capacity storage apparatus (such as a magnetic or optical disk, a flash memory) is used as a permanent storage apparatus. In other embodiments, the permanent storage apparatus may be a removable storage device (such as a floppy disk, an optical drive). The system memory may be a readable and writable storage device or a volatile readable and writable storage device, such as a dynamic random access memory. The system memory may store some or all instructions and data required by the processor at runtime. In addition, the memory 410 may include any combination of computer-readable storage media, including various types of semiconductor memory chips (a DRAM, an SRAM, an SDRAM, a flash memory, a programmable read-only memory), and disks and/or optical disks may also be used. In some embodiments, the memory 410 may include a readable and/or writable removable storage device, such as a laser disc (CD), a read-only digital versatile disc (such as a DVD-ROM, a double-layer DVD-ROM), a read-only Blu-ray disc, an ultra-density optical disc, a flash memory card (such as an SD card, a min SD card, a Micro-SD card, etc.), a magnetic floppy disk, etc. Computer-readable storage media do not include carrier waves and instantaneous electronic signals transmitted wirelessly or wired.

The memory 410 stores executable codes, which, when processed by the processor 420, can cause the processor 420 to execute the method of using the heterogeneous server system described above.

The heterogeneous server system and the method of using the same according to the present invention has been described in detail above with reference to the accompanying drawings.

In addition, the method according to the present invention can also be implemented as a computer program or a computer program product, which includes computer program code instructions for executing the above steps defined in the above method of the present invention.

Or, the present invention can also be implemented as a non-transitory machine-readable storage medium (or a computer-readable storage medium, or a machine-readable storage medium), on which executable codes (or a computer program, or computer instruction codes) are stored, and when the executable codes (or a computer program, or the computer instruction codes) are executed by a processor of an electronic device (or a computing device, a server, etc.), the processor is caused to execute the various steps of the above method according to the present invention.

It will also be understood by those skilled in the art that the various exemplary logic blocks, modules, circuits, and algorithm steps described in conjunction with the disclosure herein can be implemented as electronic hardware, computer software, or a combination of the two.

The flowcharts and block diagrams in the accompanying drawings show the possible architectures, functions, and operations of the systems and methods according to multiple embodiments of the present invention. In this regard, each block in a flowchart or a block diagram may represent a module, a program segment, or a portion of codes that contains one or more executable instructions for implementing a specified logical function. It should also be noted that in some alternative implementations, the functions marked in the blocks may also occur in an order different from that marked in the accompanying drawings. For example, two consecutive blocks may actually be executed substantially in parallel, and they may sometimes be executed in a reverse order, depending on the functions involved. It should also be noted that each block in a block diagram and/or a flowchart, and a combination of blocks in a block diagram and/or a flowchart, may be implemented with a dedicated hardware-based system that performs a specified function or operation, or may be implemented with a combination of dedicated hardware and computer instructions.

The above description of various embodiments of the present invention is exemplary, not exhaustive, and is not limited to the disclosed embodiments. Many modifications and changes are obvious to those of ordinary skill in the art without departing from the scope and the spirit of the described embodiments. The terms used herein are selected to best explain the principles, practical application or improvement to technologies in the market of the embodiments, or to enable other of ordinary skills in the art to understand the embodiments disclosed herein.

1. A heterogeneous server system, comprising:
a first computing node, configured to provide a first service;
a second computing node, configured to provide a second service; and
a computing resource node, comprising a switch and a computing processing unit connected to the switch,
wherein the computing processing unit is configured to perform at least a part of a computing task of the first service or the second service,
wherein the switch is connected to the first computing node and the second computing node, and is switchable between a first state and a second state, wherein in the first state, the switch connects the computing processing unit to the first computing node, and in the second state, the switch connects the computing processing unit to the second computing node.

2. The heterogeneous server system according to claim 1, wherein
the switch is a peripheral component interconnect express (PCIe) switch;
the computing processing unit is connected to a downstream port of the switch via a PCIe cable;
the first computing node and the second computing node are connected to a first port and a second port of the switch via a PCIe cable, respectively, and in the first state, the first port is set as an upstream port of the switch and the second port is closed, and in the second state, the second port is set as the upstream port of the switch and the first port is closed.

3. The heterogeneous server system according to claim 2, wherein
the computing resource node further comprises a baseboard management controller, and switching of the switch between the first state and the second state is implemented by the baseboard management controller changing a firmware of the switch.

4. The heterogeneous server system according to claim 2, wherein
the computing resource node further comprises a baseboard management controller, the switch further comprises an internal processor, and switching of the switch between the first state and the second state is implemented as follows:
the switch is configured to enable the baseboard management controller to communicate with the internal processor;
the internal processor obtains and saves a PCIe topology of the downstream port;
in the first state, the baseboard management controller configures the first port as the upstream port of the switch and closes the second port, and the switch provides the PCIe topology to the first computing node; and
in the second state, the baseboard management controller configures the second port as the upstream port of the switch and closes the first port, and the switch provides the PCIe topology to the second computing node.

5. The heterogeneous server system according to claim 1- or 2, wherein
the heterogeneous server system comprises a plurality of second computing nodes;
the computing resource node comprises a plurality of switches and a plurality of computing processing units;
wherein the plurality of computing processing units are divided into a plurality of groups, and each group is connected to one of the plurality of switches;
wherein the first computing node is connected to at least two of the plurality of switches;
wherein each of the plurality of second computing nodes is connected to at least one of the plurality of switches, and a quantity of switches connected with the second computing node is calculated based on a quantity of computing processing units required for the second service and a connection architecture between the computing processing units and the switches; and
wherein a quantity of switches connected with the first computing node is greater than the quantity of switches connected with the second computing node.

6. The heterogeneous server system according to claim 1, wherein
the computing processing unit is a graphics processing unit (GPU); and/or
each of the first computing node and the second computing node comprises a central processing unit (CPU) and a memory; and/or
the first service is an artificial intelligence training service; and/or
the second service is an artificial intelligence inference service.

7. The heterogeneous server system according to claim 1, wherein
the computing resource node further comprises at least one of following items:
a first interface for connecting the first computing node to a first port of the switch;
a second interface for connecting the second computing node to a second port of the switch; or
a memory interface for connecting the memory to a third port of the switch.

8. A method of using the heterogeneous server system according to claim 1 to perform a computing task, comprising:
determining whether the computing processing unit connected with the switch is used for the first service or the second service;
configuring the switch to the first state in a case where the computing processing unit connected with the switch is used for the first service; and
configuring the switch to the second state in a case where the computing processing unit connected with the switch is used for the second service.

9. The method according to claim 8, wherein
the switch is a peripheral component interconnect express (PCIe) switch;
the computing processing unit is connected to a downstream port of the switch via a PCIe cable;
the first computing node and the second computing node are connected to a first port and a second port of the switch via a PCIe cable, respectively;
the computing resource node further comprises a baseboard management controller, the step of configuring the switch to the first state comprises:
setting, by the baseboard management controller, a firmware of the switch to a first firmware;
setting, by the first firmware, the first port as an upstream port of the switch so as to connect to the downstream port, and closing the second port;
and/or, the step of configuring the switch to the second state comprises:
setting, by the baseboard management controller, the firmware of the switch to a second firmware; setting, by the second firmware, the second port as the upstream port of the switch so as to connect to the downstream port, and closing the first port.

10. The method according to claim 8, wherein
the switch is a PCIe switch;
the computing processing unit is connected to a downstream port of the switch via a PCIe cable;
the first computing node and the second computing node are connected to a first port and a second port of the switch via a PCIe cable, respectively;
the computing resource node further comprises a baseboard management controller, and the switch further comprises an internal processor,
the step of configuring the switch to the first state comprises:
configuring the switch so that the baseboard management controller communicates with the internal processor;
obtaining and saving, by the internal processor, a PCIe topology of the downstream port; and
configuring, by the baseboard management controller, the first port as an upstream port of the switch and closing the second port, and providing, by the switch, the PCIe topology to the first computing node;
and/or, the step of configuring the switch to the second state comprises:
configuring the switch so that the baseboard management controller communicates with the internal processor;
obtaining and saving, by the internal processor, the PCIe topology of the downstream port; and
configuring, by the baseboard management controller, the second port as the upstream port of the switch and closing the first port, and providing, by the switch, the PCIe topology to the second computing node.

11. The method according to claim 8, wherein
the heterogeneous server system comprises a plurality of second computing nodes;
the computing resource node comprises a plurality of switches and a plurality of computing processing units;
the plurality of computing processing units are divided into a plurality of groups, and each group is connected to one of the plurality of switches;
the first computing node is connected to at least two of the plurality of switches;
each of the plurality of second computing nodes is connected to at least one of the plurality of switches, and a quantity of switches connected with the second computing node is calculated based on a quantity of computing processing units required for the second service and a connection architecture between the computing processing units and the switches;
a quantity of switches connected with the first computing node is greater than the quantity of switches connected with the second computing node; and
the step of determining whether the computing processing unit connected with the switch is used for the first service or the second service comprises:
determining quantities of computing processing units used for the first service and the second service, respectively, among the plurality of computing processing units, according to quantities of the first service and the second service to be provided by the heterogeneous server system; and
allocating the plurality of computing processing units to the first service and the second service respectively according to the connection architecture between the computing processing units and the switches, a connection architecture between the first computing node, the second computing nodes and the switches, and the quantity of computing processing units required for each service.

12. A computing device, comprising:
a processor; and
a memory, on which executable codes are stored, wherein when the executable codes are executed by the processor, the processor is caused to execute the method according to claim 8.

13. (canceled)

14. A non-transitory machine-readable storage medium, on which executable codes are stored, wherein when the executable codes are executed by a processor of an electronic device, the processor is caused to execute the method according to claim 8.

15. The heterogeneous server system according to claim 2, wherein
the heterogeneous server system comprises a plurality of second computing nodes;
the computing resource node comprises a plurality of switches and a plurality of computing processing units;
wherein the plurality of computing processing units are divided into a plurality of groups, and each group is connected to one of the plurality of switches;
wherein the first computing node is connected to at least two of the plurality of switches;
wherein each of the plurality of second computing nodes is connected to at least one of the plurality of switches, and a quantity of switches connected with the second computing node is calculated based on a quantity of computing processing units required for the second service and a connection architecture between the computing processing units and the switches; and
wherein a quantity of switches connected with the first computing node is greater than the quantity of switches connected with the second computing node.

16. The heterogeneous server system according to claim 3, wherein
the heterogeneous server system comprises a plurality of second computing nodes;
the computing resource node comprises a plurality of switches and a plurality of computing processing units;
wherein the plurality of computing processing units are divided into a plurality of groups, and each group is connected to one of the plurality of switches;
wherein the first computing node is connected to at least two of the plurality of switches;
wherein each of the plurality of second computing nodes is connected to at least one of the plurality of switches, and a quantity of switches connected with the second computing node is calculated based on a quantity of computing processing units required for the second service and a connection architecture between the computing processing units and the switches; and
wherein a quantity of switches connected with the first computing node is greater than the quantity of switches connected with the second computing node.

17. The heterogeneous server system according to claim 4, wherein
the heterogeneous server system comprises a plurality of second computing nodes;
the computing resource node comprises a plurality of switches and a plurality of computing processing units;
wherein the plurality of computing processing units are divided into a plurality of groups, and each group is connected to one of the plurality of switches;
wherein the first computing node is connected to at least two of the plurality of switches;
wherein each of the plurality of second computing nodes is connected to at least one of the plurality of switches, and a quantity of switches connected with the second computing node is calculated based on a quantity of computing processing units required for the second service and a connection architecture between the computing processing units and the switches; and
wherein a quantity of switches connected with the first computing node is greater than the quantity of switches connected with the second computing node.

18. The heterogeneous server system according to claim 2, wherein
the computing resource node further comprises:
a first interface for connecting the first computing node to a first port of the switch; and/or
a second interface for connecting the second computing node to a second port of the switch; and/or
a memory interface for connecting the memory to a third port of the switch.

19. The method according to claim 9, wherein
the heterogeneous server system comprises a plurality of second computing nodes;
the computing resource node comprises a plurality of switches and a plurality of computing processing units;
the plurality of computing processing units are divided into a plurality of groups, and each group is connected to one of the plurality of switches;
the first computing node is connected to at least two of the plurality of switches;
each of the plurality of second computing nodes is connected to at least one of the plurality of switches, and a quantity of switches connected with the second computing node is calculated based on a quantity of computing processing units required for the second service and a connection architecture between the computing processing units and the switches;
a quantity of switches connected with the first computing node is greater than the quantity of switches connected with the second computing node; and
the step of determining whether the computing processing unit connected with the switch is used for the first service or the second service comprises:
determining quantities of computing processing units used for the first service and the second service, respectively, among the plurality of computing processing units, according to quantities of the first service and the second service to be provided by the heterogeneous server system; and
allocating the plurality of computing processing units to the first service and the second service respectively according to the connection architecture between the computing processing units and the switches, a connection architecture between the first computing node, the second computing nodes and the switches, and the quantity of computing processing units required for each service.

20. The method according to claim 10, wherein
the heterogeneous server system comprises a plurality of second computing nodes;
the computing resource node comprises a plurality of switches and a plurality of computing processing units;
the plurality of computing processing units are divided into a plurality of groups, and each group is connected to one of the plurality of switches;
the first computing node is connected to at least two of the plurality of switches;
each of the plurality of second computing nodes is connected to at least one of the plurality of switches, and a quantity of switches connected with the second computing node is calculated based on a quantity of computing processing units required for the second service and a connection architecture between the computing processing units and the switches;
a quantity of switches connected with the first computing node is greater than the quantity of switches connected with the second computing node; and
the step of determining whether the computing processing unit connected with the switch is used for the first service or the second service comprises:
determining quantities of computing processing units used for the first service and the second service, respectively, among the plurality of computing processing units, according to quantities of the first service and the second service to be provided by the heterogeneous server system; and allocating the plurality of computing processing units to the first service and the second service respectively according to the connection architecture between the computing processing units and the switches, a connection architecture between the first computing node, the second computing nodes and the switches, and the quantity of computing processing units required for each service.
